(19) United States
(12) Patent Application Publication
(10) Pub. No.: US 2008/0307659 A1
(43) Pub. Date: Dec. 18, 2008

(54) CAN OPENER

(76) Inventor: Dale J. Freeman, Edwards, NY (US)

Correspondence Address: RICHARD D. FUERLE, 1711 W. RIVER RD., GRAND ISLAND, NY, 14072, US

(21) Appl. No.: 11/531,088

(22) Filed: Sep. 12, 2006

(51) Int. Cl. B67B 7/46

(52) U.S. Cl. 30/410

(57) ABSTRACT

A cylindrical can that contains both solids and a liquid has a vertical longitudinal axis, circular sides, a horizontal circular lid and bottom, and a rim around the periphery of the lid that extends beyond the sides. The can is opened and the liquid is separated from the solids in the can by a can opener that has a can holder, an arm, a head, a screw, and at least one cutter. The can holder has an opening that has a diameter greater than the diameter of the sides and lesser than the diameter of the rim, so that when the can is placed in the opening the can holder supports it by its rim. The arm extends over the opening and is attached to the can holder. The screw is centered on the longitudinal axis and threadedly engages the arm. The lower end of the screw is fixed to the head, which has a diameter that is less than the diameter of the lid. The cutters are attached to the head and are positioned near the periphery of the lid, for cutting the lid off the can. Rotating the screw rotates the cutters, cutting off the lid and pressing the head against the lid to force the liquid out from under the lid.

### BACKGROUND OF THE INVENTION

This invention relates to a device for opening cans that contain solids and liquid and for removing the liquid from the can. In particular, it relates to a device that cuts the lid off a can and presses the lid against the solid contents in the can to squeeze liquid out of the can.

A number of solid products are sold in cans along with a liquid, which usually is present to protect the quality of the product. Tuna fish, for example, is commonly sold in cylindrical cans with water, vegetable oil, or olive oil to preserve the product and its taste. Consuming the tuna fish requires opening the can and separating and discarding the liquid. This may be accomplished by using a conventional can opener then pressing the lid down upon the tuna fish, thereby forcing the liquid out. However, considerable force is required to remove most of the liquid and if the hands slip they may be cut on the edge of the can.

In U.S. Pat. No. 6,092,640 removing the liquid is accomplished by means of a strainer that is pressed against the tuna fish, thereby keeping the fingers out of the can. However, the can must still be opened with a separate can opener. Also, tuna fish can be pressed through the strainer and lost or it may be difficult to remove bits of tuna fish that become trapped on the strainer.

### SUMMARY OF THE INVENTION

The device of this invention performs two functions, both opening the can and squeezing liquid out of the can. This is accomplished by turning a handle that causes cutters to revolve around the inside of the lid of the can then, when the lid is detached from the can, turning the handle presses the lid down against the solids in the can, thereby forcing liquid out from under the lid. The device may be equipped with a magnet to hold the lip once it is detached so that it is not necessary to touch the lid while opening the can or squeezing liquid out of it. The device may also be equipped with grips so that the can does not turn while it is being opened and with stops so that the cutters do not cut into the bottom of the can.

### BRIEF DESCRIPTION OF THE DRAWINGS

FIG. 1 is a side view of a certain presently preferred embodiment of a can opener according to this invention holding a can.

FIG. 2 is a top view of the can opener shown in FIG. 1 without a can.

FIG. 3 is a bottom view of the can opener shown in FIG. 1 without a can.

FIG. 4 is an end view of the can opener shown in FIG. 1 without a can.

### DESCRIPTION OF THE PREFERRED EMBODIMENTS

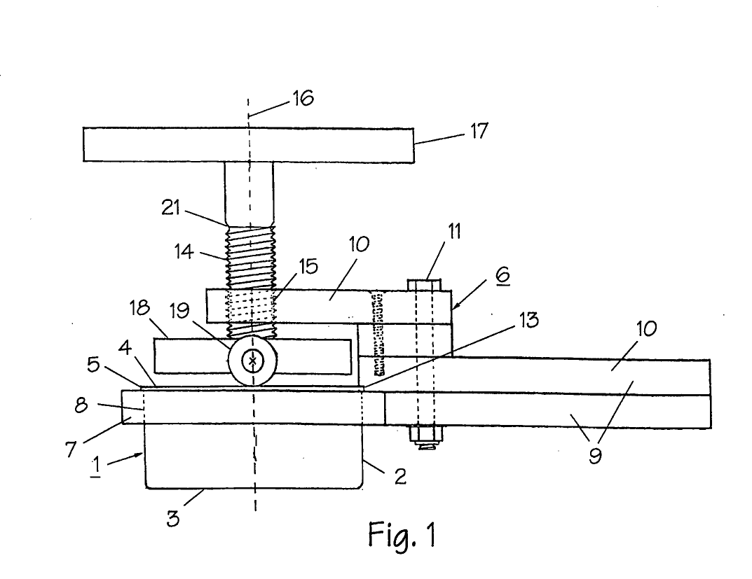

In FIG. 1, can 1 has cylindrical sides 2 to which is sealed bottom 3 and lid 4. Extending outward from the periphery of the top of sides 2 is circumferential rim 5; there is preferably no outwardly extending rim at the bottom of can 1. Can 1 holds both a solid and a liquid. For example, can 1 may hold a food, such as a meat or fish product (e.g., ham, tuna fish, salmon, sardines, fruit, clams, turkey, chicken, crab, bean sprouts, cat food, or dog food) along with a liquid (e.g., water, vegetable oil, olive oil, or seasoned or flavored water). Can 1 may also contain non-food solids and liquids. Preferably, can 1 holds tuna fish. For a 6 oz. can of tuna fish, the height of can 1 is about 1⅜ to about 1½ inches and the diameter of can 1 is about 3 11/32 to about 3 5/16 inches; for a 12 oz. can of tuna fish, the height of can 1 is about 2 1/32 to about 2 1/16 inches and the diameter of can 1 is about 3 29/32 to about 3 15/16 inches.

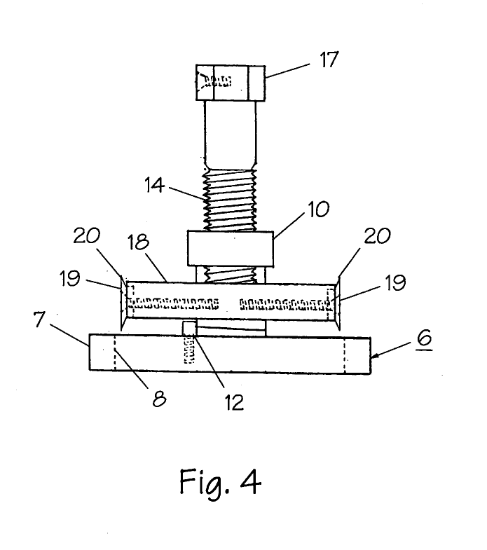

In FIGS. 1, 2, 3, and 4, can opener 6 has can holder 7 that has circular opening 8 into which is inserted can 1. The diameter of opening 8 is slightly greater than the outside diameter of the sides 2 of can 1 but is slightly less than the diameter of rim 5, so that can 1 can be easily slipped into opening 8 and will be supported on holder 7 by rim 5. For a 6 oz. can of tuna fish, the diameter of opening 8 would be about 3 11/32 to about 3 5/16 inches and for a 12 oz. can of tuna fish, the diameter of opening 8 would be about 3 29/32 to about 3 15/16 inches.

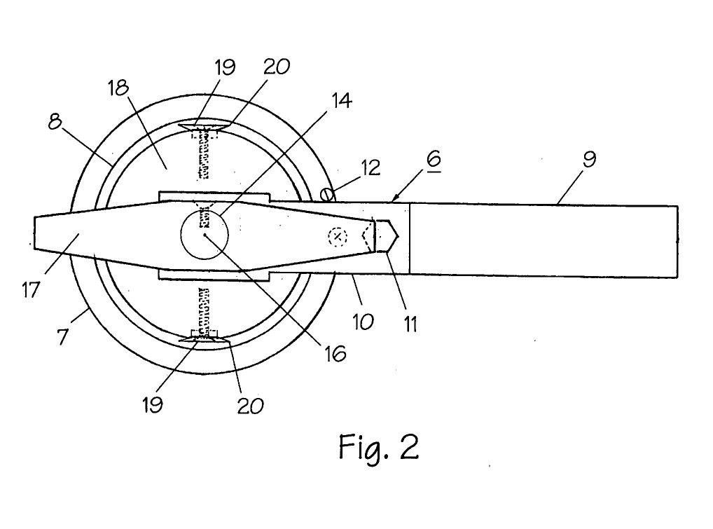

Handle 9, to which can holder 7 is fixed, enables a person to pick up can opener 6 with one hand. Arm 10 is rotatably attached to handle 9 by means of bolt 11, so that arm 10 can rotate about bolt 11 from the position shown in FIG. 1 to about 90° from that position. Stop 12 (FIG. 2) centers arm 10 directly over can 1. Thus, arm 10 is rotated to the 90° position to insert and remove can 1 from opening 8 and is rotated to the position shown in FIG. 1 to open can 1. Arm 10 is provided with an indentation 13 that grips can 1 to prevent it from turning.

Screw 14 passes through threaded aperture 15 in arm 10, so that the threads of screw 14 engage the threads of aperture 15. The longitudinal axes 16 of screw 14 and can 1 coincide. Lever 17, fixed to the top of screw 14, enables the user to rotate screw 14, which moves screw 14 up and down.

To the lower end of screw 14 is fixed circular head 18. The diameter of head 18 is slightly less than the diameter of lid 4. To opposing sides of head 18 are rotatably attached disc-shaped cutters 19, each of which has sharp edge 20 at its periphery. Cutters 19 are preferably about ¾ to about 13/16 inches in diameter, but may have other dimensions if desired. Each cutter 19 is positioned with its axis of rotation approximately parallel to lid 4 and so that sharp edge 20 extends below head 18, preferably about 3/16 to about ¼ inches below, and is near the periphery of lid 4. Screw 14 has a stop 21 (the end of the threads) that prevents cutters 19 from moving downward enough to contact and cut bottom 3 of can 1. Cutters 19 preferably move up and down about 1 1/16 to about 1⅛ inches.

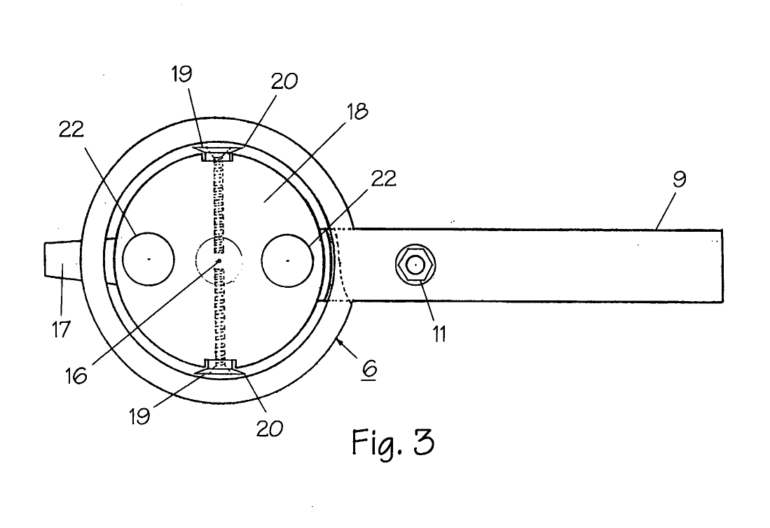

For a 6 oz can of tuna fish, for example, cutters 19 should be about 3 3/32 to about 3⅛ inches apart. If desired, the distance between cutters 19 can be made adjustable, for example by threadedly mounting them on a screw that is perpendicular to axis 16, the screw having left-handed threads on one side and right-handed threads on the other, so that rotating the screw moves the cutters an equal amount towards or away from axes 16. While two cutters are preferred, one or more than two cutters may be used if desired. In addition to disc-shaped cutters, cutters that are blades or have other forms may also be used, though disc-shaped cutters are preferred as they have been found to work well. To the bottom of head 18 are attached two magnets 22 (FIG. 3) that hold the lid after the water has been removed from the can and the can is removed from can opener 6.

While in FIGS. 1 to 4, can holder 7 completely encircles can 1 so that opening 8 is circular, it is also contemplated that can 1 may be held by other means. For example, can holder 7 may have a slot of greater width than the diameter of sides 2, so that can 1 can be inserted into position for opening by sliding it through the slot instead of dropping it into an opening. For that embodiment, it would not necessary for arm 10 to be rotatably attached to handle 9 and cans could be opened that have an outwardly-extended rim at bottom as well as at the top.

The can opener may be made from a variety of materials, including plastics and metals, but aluminum and stainless steel are preferred for their durability and rust resistance.

The following example further illustrates this invention.

### EXAMPLE

A can opener as illustrated in the drawings was made by cutting the various flat parts shown in the drawings from a ½ inch thick plate of aluminum and then milling as needed. The screw was made by cutting a piece of ¾ inch aluminum rod and machining threads onto it. All the nuts and bolts were stainless steel. The cutter wheels were replacement wheels for a pipe cutter, made of high carbon steel into which were inserted ball bearings.

The can opener was successfully used to open 25 cans of tuna fish. After the cans were opened, the can opener was tilted to pour out the water.

What is claimed is:

1. A can opener for opening and removing liquid from a cylindrical can that has a vertical longitudinal axis, circular sides, a horizontal circular lid and bottom, and a rim around the periphery of said lid that has a diameter greater than the diameter of said sides, said can containing both solids and a liquid, comprising
(A) a can holder having an opening that has a diameter greater than the diameter of said sides and lesser than the diameter of said rim, whereby when said can is placed in said opening said can holder supports said can by said rim;
(B) an arm that extends over said opening and is attached to said can holder;
(C) a head of lesser diameter than said lid for pressing down upon said lid;
(D) a screw that threadedly engages said arm, where the lower end of said screw is fixed to said head; and
(E) at least one cutter attached to said head for cutting off said lid, said at least one cutter having a cutting edge that extends below said head, whereby rotating said screw cuts off said lid and presses said liquid out from under said lid.

2. A can opener according to claim 1 wherein said can holder has grips that prevent said can from rotating.

3. A can opener according to claim 1 wherein magnets in said head hold said lid when said lid is cut off said can.

4. A can opener according to claim 13 wherein said at least one cutter moves up and down a distance of about 1 1/16 to about 1⅛ inches.

5. A can opener according to claim 1 wherein said at least one cutter is two cutter wheels rotatably mounted perpendicularly to said lid on opposing sides of said head, each with a sharp edge on its periphery.

6. A can opener according to claim 5 wherein the distance between said sharp edges is about 3 3/32 to about 3⅛ inches.

7. A can opener according to claim 5 wherein the diameter of said cutter wheels is about ¾ to about 13/16 inches.

8. A can opener according to claim 1 wherein said arm is rotatably attached to said can holder, whereby said arm pivots away from said opening to permit said can to be inserted into said opening and removed from said opening.

9. A can opener according to claim 8 wherein a stop centers said screw over said can.

10. A can opener according to claim 1 wherein said screw has an axis that coincides with said vertical longitudinal axis of said can.

11. A can opener according to claim 1 wherein a stop on said screw prevents said cutters from contacting the bottom of said can.

12. A can opener according to claim 1 wherein said opening is circular and passes all the way through said head.

13. A can opener according to claim 12 wherein the diameter of said opening is about 3 11/32 to about 3 5/16 inches.

14. A can opener according to claim 1 wherein said device is made of aluminum, stainless steel, or combinations thereof.

15. A can opener according to claim 1 wherein said can is a 6 oz. can.

16. A method of opening a can that contains solids and liquid and of removing said liquid from said can comprising
(A) using a can opener according to claim 1, placing said can in said opening;
(B) rotating said screw an amount sufficient to press said at least one cutter against said lid, whereby said at least one cutter cuts through said lid, detaching said lid from said can;
(C) continuing to rotate said screw, whereby said head presses said lid into said can, forcing said liquid out from under said lid; and
(D) removing said can from said opening.

17. A can opener for opening and removing liquid from a cylindrical can that has a vertical longitudinal axis, circular sides, a horizontal circular lid and bottom, and a rim around the periphery of said lid that has a diameter greater than the diameter of said sides, said can containing both solids and a liquid, comprising
(A) a can holder having an opening that has a diameter greater than the diameter of said sides and lesser than the diameter of said rim, whereby when said can is placed in said opening said can holder supports said can by said rim;
(B) an arm that extends over said opening and is attached to said can holder;
(C) a circular head of lesser diameter than said lid for pressing down upon said lid;
(D) two cutters attached to opposing sides of said head for cutting off said lid, each cutter having a cutting edge that extends below said head;
(E) a screw that threadedly engages said arm, where the lower end of said screw is fixed to said head and the upper end of said screw is fixed to a horizontal handle, whereby rotating said handle cuts off said lid and presses said lid down into said can; and
(F) a lever attached to said screw for rotating said screw.

18. A method of opening a can that contains solids and liquid and of removing said liquid from said can comprising
(A) using a can opener according to claim 17, placing said can in said opening;
(B) rotating said screw an amount sufficient to press said cutters against said lid, whereby said cutters cut through said lid, detaching said lid from said can;
(C) continuing to rotate said screw, whereby said head presses said lid into said can, forcing said liquid out from under said lid; and
(D) removing said can from said opening.

19. A can opener for opening and removing liquid from a cylindrical can that has a vertical longitudinal axis, circular sides, a horizontal circular lid and bottom, and a rim around the periphery of said lid that has a diameter greater than the diameter of said sides, said can containing both solids and a liquid, comprising
(A) a can holder having an opening that has a diameter greater than the diameter of said sides and lesser than the diameter of said rim, whereby when said can is placed in said opening said can holder supports said can by said rim;
(B) an arm that extends over said opening and is rotatably attached to said can holder;
(C) a stop on said can holder that centers said screw over said can;
(D) a circular head of lesser diameter than said lid, said circular head having a magnetic underside;
(E) two circular cutters attached to opposing sides of said head near said rim and perpendicular to said lid, each cutter having a cutting edge that extends below said head;
(F) magnetic means on said head for magnetically attracting said lid;
(G) a vertical screw that threadedly engages said arm, where the lower end of said screw is fixed to said head;
(H) a lever attached to the upper end of said screw, whereby rotating said lever rotates said screw, presses said cutters against said lid, cuts off said lid, and presses said lid down into said can;
(I) a stop on said vertical screw that prevents said cutters from contacting said bottom; and
(J) a handle attached to said can holder for picking up said can opener.

20. A method of opening a can that contains solids and liquid and of removing said liquid from said can comprising
(A) rotating said arm of a can opener according to claim 19 away from said opening;
(B) placing said can in said opening;
(C) rotating said arm so that said screw is centered over said can;
(D) rotating said screw an amount sufficient to press said cutters against said lid, whereby said cutters cut through said lid, detaching said lid from said can;
(E) continuing to rotate said screw, whereby said head presses said lid into said can, forcing said liquid out from under said lid;
(F) tipping said can opener to allow said liquid to flow out of said can;
(G) rotating said arm away from said opening; and
(H) removing said can from said opening.
